(19) United States
(12) Patent Application Publication
(10) Pub. No.: US 2018/0073474 A1
(43) Pub. Date: Mar. 15, 2018

(54) AIR INTAKE SYSTEM FOR ENGINE

(71) Applicant: Caterpillar Inc., Peoria, IL (US)

(72) Inventor: Robert D. Clayton, JR., Peroria, IL (US)

(73) Assignee: Caterpillar Inc., Peoria, IL (US)

(21) Appl. No.: 15/265,390

(22) Filed: Sep. 14, 2016

(51) Int. Cl. F02M 35/02; B01D 53/04

(52) U.S. Cl. CPC F02M 35/0218; B01D 53/0415; B01D 2257/556; F02M 35/0201; F02M 35/0216

(57) ABSTRACT

An adsorber assembly for separating contaminants, such as siloxanes, from air is provided. The adsorber assembly includes a housing having an inlet and an outlet. The adsorber assembly also includes at least one separation module stacked within the housing. The at least one separation module includes a first cartridge having a first filter media configured to separate contaminants from the air and a second cartridge having a second filter media configured to separate contaminants from the air. The second cartridge and the first cartridge define a flow path between the first filter media and the second filter media. The flow path is in fluid communication with the inlet of the housing. The present disclosure also provides an air intake system equipped with the adsorber assembly.

### TECHNICAL FIELD

The present disclosure relates to engines and more particularly to an air intake system for an engine.

### BACKGROUND

Worksites involved in waste management contain contaminants, such as siloxanes, chlorides, and the like, diffused in the ambient air. As such, machines operating in such worksites may be exposed to the contaminants present in the ambient air. For example, siloxanes may be introduced into an engine of the machine via an air intake system and may combust to form silica. The silica may adhere to surfaces inside the engine and an exhaust aftertreatment system of the engine, and form coatings thereon. Components of the exhaust aftertreatment, such as Diesel Particulate Filter (DPF) and Diesel Oxidation Catalyst (DOC) may be particularly susceptible to such coatings, which causes restriction of exhaust flow and increase in backpressure. Additionally, coatings of silica on sensors deployed in the exhaust aftertreatment system may cause inaccurate readings or delayed responses. Therefore, high concentrations of siloxanes in the ambient air may severely affect maintenance intervals of the engine or the machine, thereby causing more downtime and triggering frequent replacement of the components.

### SUMMARY OF THE DISCLOSURE

In one aspect of the present disclosure, an adsorber assembly for separating contaminants from air is provided. The adsorber assembly includes a housing having an inlet and an outlet. The adsorber assembly also includes at least one separation module stacked within the housing. The at least one separation module includes a first cartridge having a first filter media and a second cartridge having a second filter media. The first and second filter media are configured to separate contaminants from the air. The second cartridge and the first cartridge define a flow path between the first filter media and the second filter media. The flow path is in fluid communication with the inlet of the housing.

In another aspect of the present disclosure, an air intake system is provided. The air intake system includes an air filter and a siloxane adsorber assembly in fluid communication with the air filter. The siloxane adsorber assembly includes a housing having an inlet and an outlet. The inlet is configured to receive siloxane mixed air into the housing from the air filter and the outlet is configured to supply siloxane free air. The siloxane adsorber assembly also includes at least one siloxane separation module stacked within the housing. The at least one siloxane separation module includes a first cartridge having a first filter media and a second cartridge having a second filter media. The first and second filter media are configured to separate siloxane from the siloxane mixed air. The second cartridge and the first cartridge define a flow path between the first filter media and the second filter media. The flow path is in fluid communication with the inlet of the housing. The air intake system also includes a compressor in fluid communication with the outlet of the siloxane adsorber to receive the siloxane free air from the siloxane adsorber.

In yet another aspect of the present disclosure, a siloxane separation module for separating siloxane from siloxane mixed air is provided. The siloxane separation module includes a first cartridge having a first filter media and a second cartridge having a second filter media. The first and second filter media are configured to separate siloxane from the siloxane mixed air. The second cartridge and the first cartridge define a flow path between the first filter media and the second filter media. The flow path is in fluid communication with the inlet of the housing.

Other features and aspects of this disclosure will be apparent from the following description and the accompanying drawings.

### BRIEF DESCRIPTION OF THE DRAWINGS

FIG. 1 is a perspective view of an engine having an air intake system, according to an embodiment of the present disclosure;

FIG. 2 is a schematic diagram of the air intake system equipped with an adsorber assembly, according to an embodiment of the present disclosure;

FIG. 3 is a perspective view of the adsorber assembly of FIG. 2, according to an embodiment of the present disclosure;

FIG. 4 is a perspective cross-section of the adsorber assembly taken along a section A-A′ in FIG. 3, according to an embodiment of the present disclosure;

FIG. 5 is a cross-sectional view of the adsorber assembly of FIG. 3, according to an embodiment of the present disclosure;

FIG. 6 is a schematic diagram of a siloxane separation module of the adsorber assembly, according to an embodiment of the present disclosure;

FIG. 7 is a cross-sectional view of the adsorber assembly, according to another embodiment of the present disclosure; and

FIG. 8 illustrates an enlarged portion of a side cross-section view of the adsorber assembly, according to another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

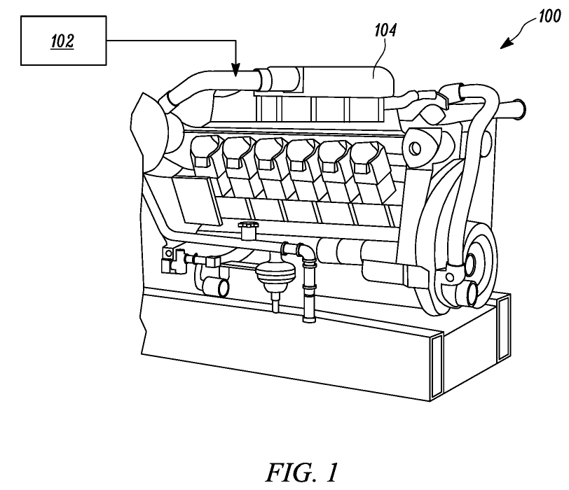

Referring to FIG. 1, according to an embodiment of the present disclosure, a perspective view of an engine 100 equipped with an air intake system 102 is illustrated. The engine 100 may be embodied as a compression ignition engine, a spark-ignition engine, or any type of combustion engine known to one skilled in the art. The engine 100 may be used in various applications such as, but not limited to, transportation, for example, in off-highway trucks, in earth-moving machines; or for power generation, for example, when coupled to a generator set; or to drive turbo-machines and/or other equipment such as, pumps and other devices known in the art. The air intake system 102 is coupled to an inlet manifold 104 of the engine 100 and allows continuous flow of air into the engine 100.

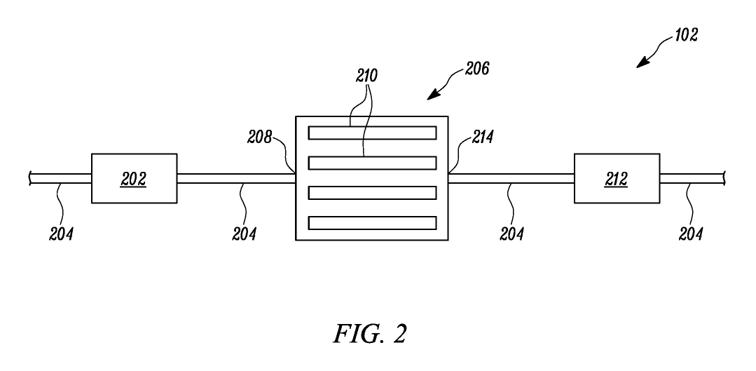

A schematic diagram of the air intake system 102 is illustrated in FIG. 2. According to the illustrated embodiment, the air intake system 102 includes an air filter 202 disposed in an airflow passage 204 upstream of the engine 100. As known in the art, the air filter 202 includes a filter strip or a porous mesh held against the flow of air in the airflow passage 204, to filter particles from the air. The air intake system 102 also includes an adsorber assembly 206 disposed downstream of the air filter 202 in the airflow passage 204. An inlet 208 of the adsorber assembly 206 is in fluid communication with the air filter 202 to receive contaminated air from the air filter 202 through the airflow passage 204. In an embodiment of the present disclosure, the air intake system 102 further includes one or more separation modules, such as a separation module 210. The separation modules 210 may be stacked in a parallel configuration within the adsorber assembly 206 for separating contaminants from the contaminated air. In one example, the contaminants or the contaminated air can at least include siloxanes. Further, a compressor 212 disposed downstream in the airflow passage 204 is in fluid communication with an outlet 214 of the adsorber assembly 206 to receive contaminant free air from the adsorber assembly 206. The compressor 212 compresses and supplies the contaminant free air to the inlet manifold 104 of the engine 100.

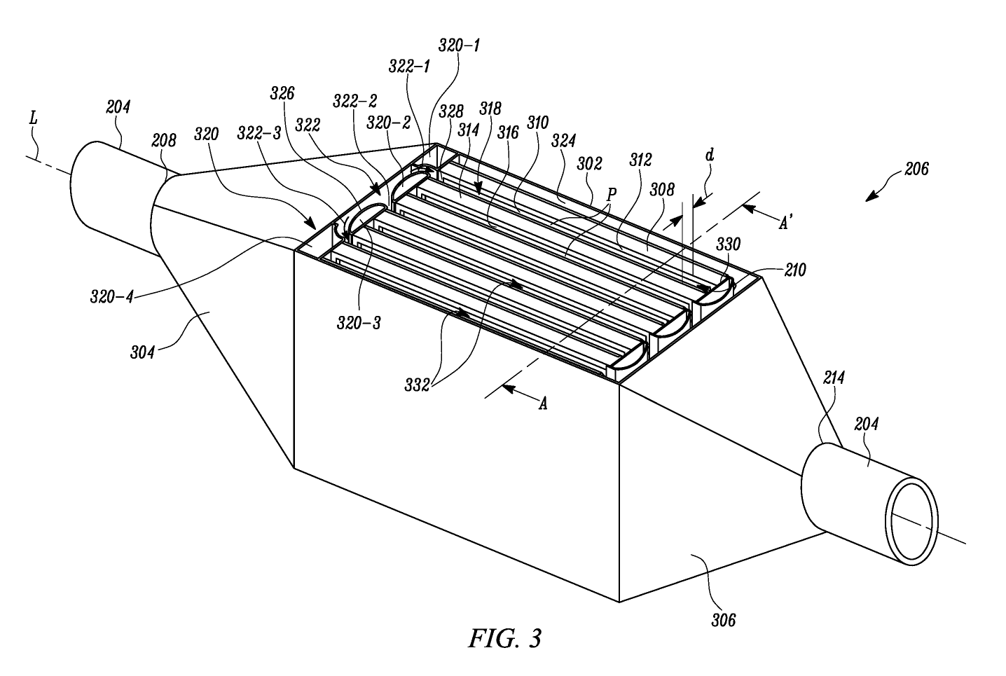

FIG. 3 illustrates a perspective view of the adsorber assembly 206, according to an embodiment of the present disclosure. In one embodiment, the adsorber assembly 206 may be embodied as a siloxane adsorber assembly for separating siloxane from siloxane mixed air. Accordingly, for the purpose of this description, the adsorber assembly 206 is alternatively referred to as the siloxane adsorber assembly 206. As such, configuration of the siloxane adsorber assembly 206 would be same as that of the adsorber assembly 206. In one embodiment, the siloxane adsorber assembly 206 includes a housing 302 that extends between the inlet 208 and the outlet 214. In one embodiment, the outlet 214 is located opposite to the inlet 208 of the siloxane adsorber assembly 206. In another embodiment, the inlet 208 and the outlet 214 may be provided at different locations in different planes. For instance, the inlet 208 and the outlet 214 may be provided at right angles to each other. In one embodiment, the housing 302 is embodied as a cuboidal structure having an inlet header 304 that tapers towards the inlet 208 and an outlet header 306 that tapers towards the outlet 214, as shown in FIG. 3. The tapered inlet header 304 and outlet header 306 minimize back pressure in the airflow passage 204. However, in some embodiments, the housing 302 can be structured unlike that illustrated in FIG. 3, albeit with few variations.

As mentioned earlier, the siloxane adsorber assembly 206 includes multiple separation modules 210, hereinafter alternatively referred to as the siloxane separation modules 210. Further, the siloxane separation modules 210 are hereinafter individually referred to as the module 210. In an example, the siloxane adsorber assembly 206 can include at least one module 210. The modules 210 are stacked within the housing 302 along a central longitudinal axis ‘L’, as shown in FIG. 3. Each module 210 includes a first cartridge 308 having a first filter media 310 and positioned along the central longitudinal axis 1′ of the housing 302. The first cartridge 308 is embodied as a rectangular panel having a frame 312 configured to secure the first filter media 310. Length and breadth of the frame 312 can be predetermined so that the first cartridge 308 can be inserted into the housing 302. In an example, the frame 312 may be manufactured from aluminum or any other type of material durable enough to withstand the conditions on a mobile application. Further, in an example, the thickness of the first cartridge 308 may vary along the length of the first cartridge 308 to minimize restriction and maximize siloxane separation. It will be understood that shape and size of the first cartridge 308 may be complimentary to a shape and size of the housing 302. With such arrangements, volume available within the housing 302 can be utilized to maximum extent for stacking the modules 210. For example, when the housing 302 includes an oval cross-section, the first cartridge 308 can also be provided as an oval panel having perimeter less than that of an inner surface 324 of the housing 302, so that the first cartridge 308 can be received within the housing 302. In one embodiment, the first filter media 310 is provided as a permeable material, periphery of which is secured to the frame 312. As such, the first filter media 310 includes multiple pores ‘P’ provided throughout the surface of the first filter media 310 to allow percolation of the siloxane mixed air therethrough.

In this embodiment, the module 210 also includes a second cartridge 314 having a second filter media 316. The second cartridge 314 is provided as another rectangular panel identical to the first cartridge 308. Other attributes of the second cartridge 314, such as the shape and size, may be same as that of the first cartridge 308. The second filter media 316 also includes multiple pores ‘P’ provided throughout the surface of the second filter media 316 to allow percolation of the siloxane mixed air therethrough. Periphery of each pore ‘P’ of the first filter media 310 and the second filter media 316 includes siloxane adsorbent. With such configuration, each of the first filter media 310 and the second filter media 316 are configured to separate siloxane from the siloxane mixed air.

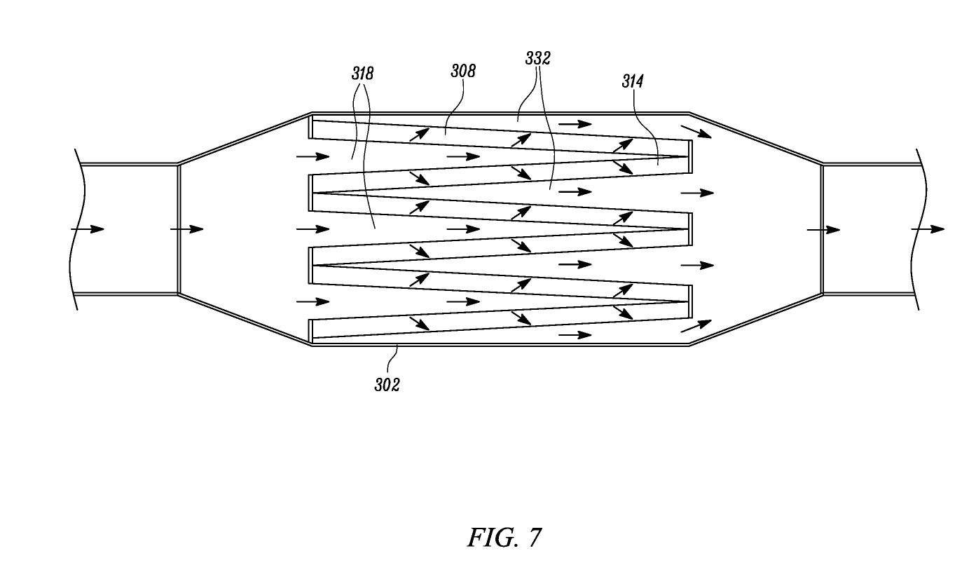

The second cartridge 314 is positioned at a predefined distance ‘d’ from the first cartridge 308 to define a flow path 318 between the first filter media 310 and the second filter media 316. In an embodiment, the second cartridge 314 may be positioned parallel to the first cartridge 308, thereby defining uniform width of the flow path 318 along the breadth of the first cartridge 308 and the second cartridge 314. However, in some embodiments, the second cartridge 314 can also be positioned at an angle with respect to the first cartridge 308, as illustrated in FIG. 7.

In one embodiment, the housing 302 includes wall structures 320-1, 320-2, 320-3, and 320-4, alternatively and commonly referred to as the wall structures 320, as shown in FIG. 3. The wall structures 320 extend vertically along length (or height) of the housing 302 and are spaced apart along breadth of the housing 302 to define at least one passage 322 in the housing 302. For instance, a first wall structure 320-1 and a second wall structure 320-2 with spaced-apart relationship define a first passage 322-1 that fluidly connects the inlet 208 and the flow path 318. Similarly, the second wall structure 320-2 and a third wall structure 320-3 with spaced-apart relationship define a second passage 322-2 therebetween that fluidly connects the inlet 208 and the flow path 318 of an adjacent module 210, as shown in FIG. 3. Likewise, the third wall structure 320-3 and the fourth wall structure 320-4 with spaced-apart relationship define a third passage 322-3 therebetween that fluidly connects the inlet 208 and the flow path 318 of another module 210. Therefore, the flow path 318 is in fluid communication with the inlet 208. The first wall structure 320-1 and the fourth wall structure 320-4 protrude from an inner surface 324 of the housing 302 and extend vertically along the length of the housing 302. The second wall structure 320-2 and the third wall structure 320-3 include an arcuate portion 326 that provides minimum resistance to the siloxane mixed air impinging thereon and allows routing of the siloxane mixed air towards the passages 322-1, 322-2, and 322-3. Further, the passages 322-1, 322-2, and 322-3 are configured to route the siloxane mixed air from the inlet 208 to the respective flow paths 318 of the modules 210.

Although the wall structures 320 herein are described and illustrated with respect to specific shape and disposition within the housing 302, it should be understood that such description and illustration do not limit the scope of the present disclosure. Instead, such description and illustration should be treated as example embodiments and variations may be made to the embodiments of the wall structures 320 described herein whilst defining the passages 322. In some embodiments, the wall structures 320 may be designed based on the inlet 208 and the outlet 214 configurations. For example, as mentioned earlier, when the inlet 208 and the outlet 214 are provided in different locations in the housing 302 and along different planes, the wall structures 320 may be designed in a manner to provide minimum restrictions to the flow of the siloxane mixed air. In addition, the number of modules 210 illustrated in FIG. 3 should not be construed as a limitation, and any number of modules 210 may be stacked within the housing 302.

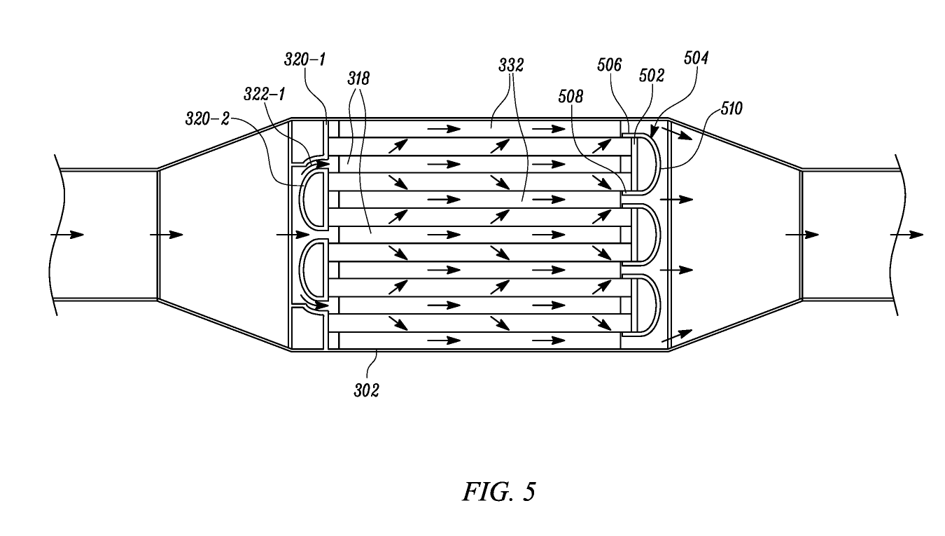

With such arrangement of the wall structures 320 and the modules 210, the flow path 318 includes an open end 328 to receive the siloxane mixed air therein and a sealing end 330 located opposite to the open end 328. The sealing end 330 is configured to prevent outflow of the siloxane mixed air from the flow path 318 and force the flow of the siloxane mixed air through at least one of the first filter media 310 and the second filter media 316. The flow of the siloxane mixed air through the filter media is described below with respect to FIG. 5.

Further, according to the illustrated embodiment, each module 210 and the inner surface 324 of the housing 302 defines a collection passage 332 therebetween. Additionally, two adjacent modules 210 also define the collection passage 332 therebetween, as shown in FIG. 3. While one end of the collection passage 332, which is proximal to the inlet 208 of the housing 302, remains blocked, the other end remains open. For example, the collection passage 332 located at leftmost of the housing 302 in FIG. 3 is blocked at one end by the first wall structure 320-1 while the other end is kept open. Similarly, the collection passage 332 formed between the module 210 along the central longitudinal axis 1′ has its one end blocked by the second wall structure 320-2 and the other end open. Such blocked end of the collection passage 332 restricts siloxane free air from mixing with the incoming siloxane mixed air. The collection passage 332 is in fluid communication with the outlet 214 of the housing 302 to supply the siloxane free air to the compressor 212.

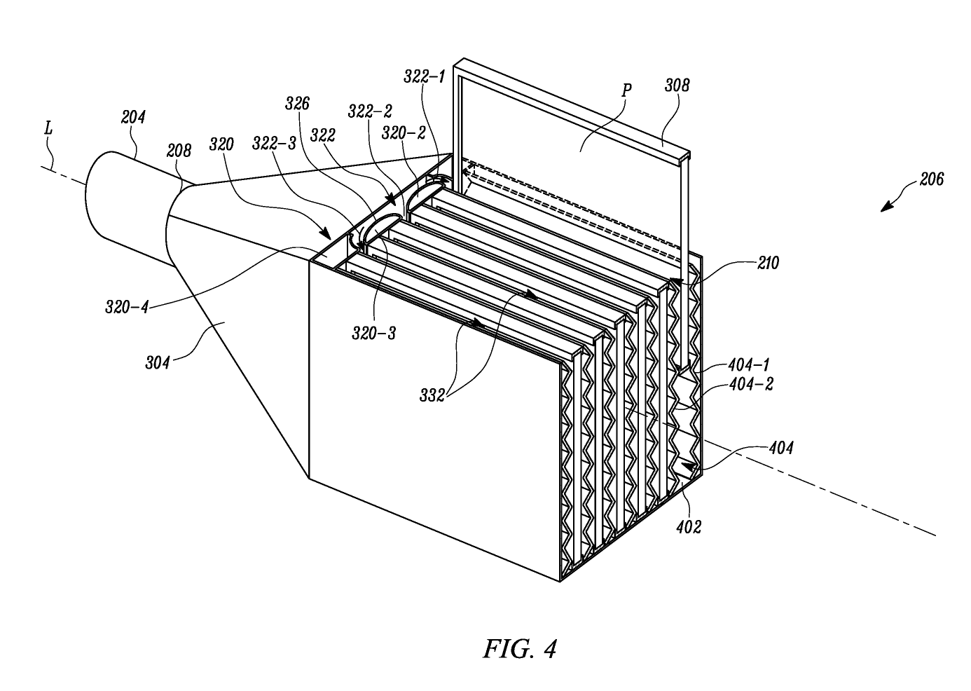

In one embodiment, the first cartridge 308 and the second cartridge 314 are removably disposed in the housing 302. For instance, as illustrated in FIG. 4, the first cartridge 308 can be pulled vertically out of the housing 302 and a replacement first cartridge 308 can be inserted. Similarly, other cartridges of other modules 210 can also be replaced. It should be understood that a face of the housing 302, such as a top face, that is absent in FIGS. 3 and 4, should be removably provided in the siloxane adsorber assembly 206 to allow access to the modules 210.

FIG. 4 illustrates a cross-section of the siloxane adsorber assembly 206 taken along a section A-A′ in FIG. 3. To support the stacking of the cartridges 308, 314, fin sheets 404 may be disposed within and between the modules 210. Specifically, the fin sheets 404 are disposed in each collection passage 332 formed by each module 210 and within the cartridges 308, 314. For instance, a first fin sheet 404-1 is disposed in the collection passage 332 formed between the first cartridge 308 and the inner surface 324 of the housing 302. Similarly, a second fin sheet 404-2 is disposed between the first cartridge 308 and the second cartridge 314, as illustrated in FIG. 4. As shown in FIG. 4, the fin sheet 404 includes a corrugated configuration. However, in some examples, the fin sheet 404 can include other configurations, such as, but not limited to, plain, perforated, serrated, herringbone, lanced offset, or louvered. Such configurations of the fin sheet 404 aid in supporting the cartridges 308, 314.

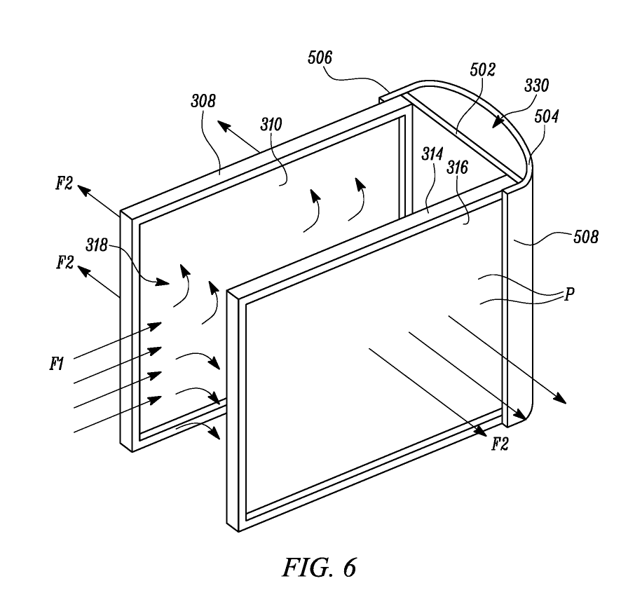

Operation of the siloxane adsorber assembly 206, i.e., separation of siloxane from the siloxane mixed air will be described with respect to FIG. 5 and FIG. 6. In particular, FIG. 5 illustrates a top cross-section view of the siloxane adsorber assembly 206. More particularly, FIG. 5 illustrates the modules 210 stacked in parallel configuration. An enlarged perspective view of one module 210, in direction is provided in FIG. 6 to illustrate the operation described with reference to FIG. 5.

As shown in FIG. 5, the first cartridge 308 is disposed between the first wall structure 320-1 and a stopper 502. Specifically, the first wall structure 320-1 and the stopper 502 are spaced apart at a distance slightly greater than the breadth of the frame 312 of the first cartridge 308, so that the first cartridge 308 can be received therebetween. The first wall structure 320-1 and the stopper 502 also aid in retaining the first cartridge 308 in a vertical manner within the housing 302. In one example, the stopper 502 may be embodied as a plate. Further, in one example, the stopper 502 can be a separate component attached to the inner surface 324 of the housing 302 at the time of assembling modules 210 into the housing 302. In another example, the stopper 502 may be an integral component of the siloxane adsorber assembly 206 that extends in a direction perpendicular to a bottom surface 402 (shown in FIG. 4) of the housing 302.

Additionally, in one embodiment, a cap 504 is also provided within the housing 302 to support the first cartridge 308 and the second cartridge 314, as shown in FIG. 3, FIG. 4, and FIG. 5. The cap 504 can either be a separate component or an integral component of the siloxane adsorber assembly 206. The first wall structure 320-1, the stopper 502, and the cap 504 serve as locating members for positioning the module 210 in the housing 302. For instance, prior to stacking the modules 210 within the housing 302, the stopper 502 and the cap 504 may be coupled within the housing 302 at a distance, as described earlier. In a coupled condition of the stopper 502 and the cap 504, the module 210 can be located vertically above the space formed between the first wall structure 320-1 and the cap 504. Subsequently, the module 210 can be inserted into the housing 302 and can be received between the first wall structure 320-1 and the stopper 502.

Further, the cap 504 includes a first arm 506 and a second arm 508 that extend parallel from a base portion 510 of the cap 504. In an example, the cap 504 can be embodied as a C-shaped or U-shaped structure. Distance between the first arm 506 and the second arm 508 can be predetermined based on the width of the flow path 318 that is required to be provided between the first filter media 310 and the second filter media 316. For example, the closer the first arm 506 and the second arm 508 are, the narrower the flow path 318 would be. In addition, the first arm 506 and the second arm 508 also assist in positioning the first cartridge 308 and the second cartridge 314 in the housing 302. As shown in FIG. 5 and FIG. 6, in an assembled condition of the module 210, the stopper 502 and the cap 504, together, serve as a sealing at one end of the flow path 318. In one embodiment, the stopper 502 and the cap 504 can be combined to form a single component. In such a case, the first arm 506 and the second arm 508 can extend perpendicularly from ends of the stopper 502. To this end, the stopper 502 and the cap 504 constitute the sealing end 330 of the flow path 318.

In operation, the siloxane mixed air is received from the air filter 202 into the housing 302, via the inlet 208. The siloxane mixed air is routed into the passage 322 and further into the flow path 318, as indicated by arrows ‘F1’. The module 210 remains covered at the bottom by the bottom surface 402 of the housing 302 (as shown in FIG. 6) and a top surface (not shown) of the housing 302. In such a condition, the siloxane mixed air is received within a cavity formed between the top surface, the bottom surface 402, the first filter media 310, and the second filter media 316. Further, the siloxane mixed air flowing into the flow path 318 is restricted from flowing out, by the stopper 502. Owing to further inflow of siloxane mixed air into the flow path 318, pressure develops within the flow path 318, thereby forcing the siloxane mixed air to flow through the first filter media 310 and the second filter media 316 (as also shown in FIG. 6). Such percolation of the siloxane mixed air through at least one of the first filter media 310 and the second filter media 316 allows the removal of siloxanes from the siloxane mixed air. In an example, flow of siloxane mixed air across the first filter media 310 and the second filter media 316 allows gas phase separation of siloxane from the siloxane mixed air. The siloxane free air, indicated by arrows ‘F2’, flows out of the first filter media 310 and the second filter media 316, and is collected in the collection passage 332. Subsequently, the siloxane free air flows to the compressor 212 via the outlet 214.

FIG. 7 illustrates a top cross-section view of the siloxane adsorber assembly 206, according to another embodiment of the present disclosure. In this embodiment, the first cartridge 308 and the second cartridge 314 are positioned in an angled design, as shown in FIG. 7, whilst defining the flow path 318 between the first filter media 310 and the second filter media 316. In particular, one end of the first cartridge 308 and a corresponding end of the second cartridge 314 are disposed in contact with each other, thereby defining the flow path 318 that narrows downstream along the breadth of the cartridges 308, 314. In one example, the cap 504 may be used to retain the above mentioned ends of the cartridges 308, 314 in contact. In another example, the bottom surface 402 may include multiple grooves (not shown) provided to receive the cartridges 308, 314, where the grooves aid in retaining the cartridges 308, 314 in the angled design while the siloxane mixed air is received within the housing 302. Owing to such angled arrangement of the cartridges 308, 314, the above mentioned ends of the cartridges 308, 314 serve as guides for the flow path 318.

In another embodiment, thickness of the first cartridge 308 and the second cartridge 314 may vary from the inlet 208 to the outlet 214. For instance, the thickness of the first cartridge 308 and the second cartridge 314 at the inlet 208 may be greater than thickness at the outlet 214. The thickness of the first cartridge 308 and the second cartridge 314 may decrease or increase along the length of the cartridges 308, 314. Such varying thickness of the cartridges 308, 314 may allow increased flow uniformity and minimize the restriction of the siloxane mixed air flow through the first filter media 310 and the second filter media 316. In addition, such configuration of the cartridges 308, 314 also minimizes back pressure developed during flow of the siloxane mixed air through the passage 322. The manner in which the separation of siloxane from the siloxane mixed air occurs in this embodiment remains the same with respect to the previous embodiments.

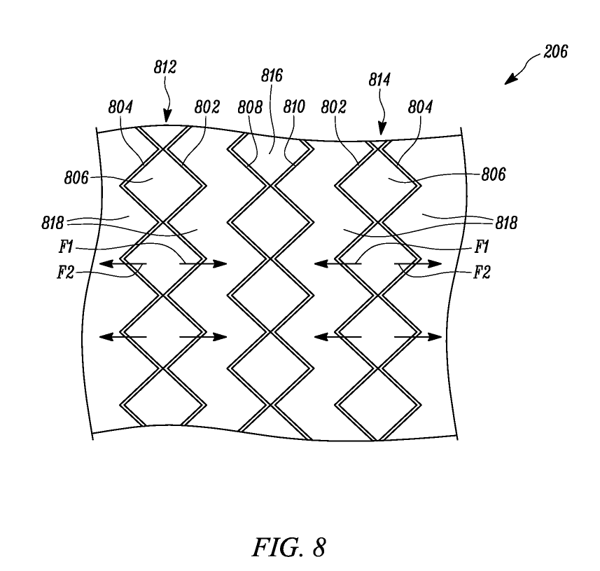

FIG. 8 illustrates an enlarged portion of a side cross-section view of the siloxane adsorber assembly 206, according to another embodiment of the present disclosure. In this embodiment, a first cartridge 802 and a second cartridge 804 are provided as corrugated sheets extending across the length of the housing 302. In an example, the first cartridge 802 and the second cartridge 804 may be made of stainless steel material or any other material able to withstand the operating conditions. The first cartridge 802 and the second cartridge 804 are positioned in an opposite manner where peaks of respective corrugated sheets are in contact with each other and define a flow path 806 therebetween. The amplitude of the peaks are optimized to maximize the removal efficiency of siloxanes and reduce the back pressure impact. In such an arrangement, the first cartridge 802 is welded to the second cartridge 804 to constitute a first siloxane separation module 812 and a second siloxane separation module 814, as shown in FIG. 8. As such, the first siloxane separation module 812 and the second siloxane separation module 814 may be replaceable. Further, the first cartridge 802 and the second cartridge 804 include porous mesh (not shown) to allow flow of siloxane mixed air across the cartridges 802 and 804. A pair of porous mesh plates 808 and 810 disposed between the first siloxane separation module 812 and the second siloxane separation module 814, as shown in FIG. 8, defines a filtrate collection passage 816 therebetween. Furthermore, siloxane adsorbent 818 is packed between the first siloxane separation module 812 and the porous mesh plate 808, and between the second siloxane separation module 814 and the porous mesh plate 810. Thickness of the siloxane adsorbent 818 is constant along the height of the first siloxane separation module 812 and the second siloxane separation module 814, but may be non-uniform to increase the flow uniformity, depending on the inlet and outlet configuration.

In the illustrated embodiment, the siloxane mixed air enters the flow path 806 in a direction perpendicular to the plane depicted by FIG. 8. Due to the pressure developed within the flow path 806, the siloxane mixed air flows across the first cartridge 802 and the second cartridge 804 in directions F1 and F2, respectively. The siloxane mixed air exiting the cartridges 802 and 804 would contact the siloxane adsorbent 818. During the flow across the siloxane adsorbent 818, siloxane is removed from the siloxane mixed air, and siloxane free air flows through the collection passage 816. The siloxane free air is further supplied to the compressor 212.

In some embodiments of the present disclosure, cartridges, such as the first cartridge 308, 802 and the second cartridge 314, 804 of the siloxane adsorber assembly 206 may be embodied as a flow through substrate, where the siloxanes would need to diffuse to the adsorbent's surface to be adsorbed. In alternative embodiments of the present disclosure, the cartridges, such as first cartridge 308, 802 and the second cartridge 314, 804 of the siloxane adsorber assembly 206 may be embodied as a wall flow filter assembly, where the wall is comprised of adsorbent material.

Although the above adsorber assembly 206 is described with regard to separation of siloxanes from ambient air, application of the adsorber assembly 206 may relate to separation of other contaminants from the air as well. For example, the adsorber assembly 206 may be configured to separate chlorides or other contaminants from the air in place of or in addition to siloxanes.

Various embodiments disclosed herein are to be taken in the illustrative and explanatory sense, and should in no way be construed as limitations to the present disclosure.

### INDUSTRIAL APPLICABILITY

The present subject matter describes the siloxane adsorber assembly 206 which includes multiple modules 210, or multiple cartridges in particular, stacked in parallel within the housing 302. Since the modules 210 are packed along the central longitudinal axis 1′ and since the flow passage 318 is along a direction in which the siloxane mixed air flows into the housing 302, possibility of development of back pressure within the housing 302 and the airflow passage 204 is minimized to a greater extent. In addition, since the first cartridge 308 and the second cartridge 314 are removably disposed within the housing 302, the cartridges 312, 314 can be replaced at end of life or during off-line regeneration of the siloxane adsorber assembly 206.

Further, owing to the presence of the sealing end 330, the siloxane mixed air entering the flow path 318 is forced to flow through the first filter media 310 and the second filter media 316. Such flow through the first filter media 310 and the second filter media 316 allows gas phase separation of siloxane from the siloxane mixed air, thereby separating the siloxanes from the siloxane mixed air. Therefore, the siloxane adsorber assembly 206 effectively separates the siloxane from the siloxane mixed air and supplies siloxane free air to the compressor 212 and the engine 100. In one embodiment, the modules 210 may be stacked in the air filter 202, thereby decreasing impact on space constraints within hood of a vehicle. In some embodiments, the number of cartridges, thickness of each cartridge, and air gap between the cartridges, that is width of the flow path 318, 806 may be predetermined to reduce backpressure and increase performance of the siloxane adsorber 206.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An adsorber assembly for separating contaminants from air, the adsorber assembly comprising:
a housing having an inlet and an outlet; and
at least one separation module stacked within the housing and comprising:
a first cartridge having a first filter media configured to separate contaminants from the air; and
a second cartridge having a second filter media configured to separate contaminants from the air, the second cartridge and the first cartridge defining a flow path between the first filter media and the second filter media, wherein the flow path is in fluid communication with the inlet of the housing.

2. The adsorber assembly of claim 1, wherein the contaminants include at least siloxanes, and wherein the first cartridge is positioned parallel and at a predefined distance with respect to the second cartridge defining the flow path between the first filter media and the second filter media.

3. The adsorber assembly of claim 1, wherein the first cartridge is positioned at an angle with respect to the second cartridge defining the flow path between the first filter media and the second filter media.

4. The adsorber assembly of claim 1, wherein at least one of the first filter media and the second filter media allow percolation of the contaminated air from the flow path to the outlet of the housing.

5. The adsorber assembly of claim 1, wherein the inlet is in fluid communication with an air filter and the outlet is in fluid communication with a compressor.

6. The adsorber assembly of claim 1, wherein the housing comprises at least one passage configured to route the contaminated air from the inlet to the flow path of each separation module.

7. The adsorber assembly of claim 1, wherein the first cartridge and the second cartridge are removably disposed along a central longitudinal axis of the housing.

8. The adsorber assembly of claim 1, wherein the flow path comprises a sealing end configured to:
restrict outflow of the contaminated air from the flow path; and
allow percolation of the contaminated air through at least one of the first filter media and the second filter media.

9. The adsorber assembly of claim 1, wherein the at least one separation module and one of an inner surface of the housing and an adjacent separation module define a collection passage therebetween.

10. The adsorber assembly of claim 9, wherein the collection passage is in fluid communication with the outlet of the housing.

11. The adsorber assembly of claim 1, wherein each of the first filter media and the second filter media comprises a plurality of pores configured to allow percolation of the contaminated air therethrough, and wherein periphery of each of the plurality of pores comprises adsorbent.

12. An air intake system comprising:
an air filter;
a siloxane adsorber assembly in fluid communication with the air filter, the siloxane adsorber assembly comprising:
a housing having an inlet configured to receive siloxane mixed air into the housing from the air filter and an outlet, the outlet configured to supply siloxane free air; and
at least one siloxane separation module stacked within the housing and comprising:
a first cartridge having a first filter media configured to separate siloxane from siloxane mixed air; and
a second cartridge having a second filter media configured to separate siloxane from the siloxane mixed air, the second cartridge and the first cartridge defining a flow path between the first filter media and the second filter media, wherein the flow path is in fluid communication with the inlet of the housing; and
a compressor in fluid communication with the outlet of the siloxane adsorber assembly to receive the siloxane free air from the siloxane adsorber.

13. The air intake system of claim 12, wherein the housing comprises at least one passage configured to route the siloxane mixed air from the inlet to the flow path of each siloxane separation module.

14. The air intake system of claim 12, wherein the flow path comprises a sealing end configured to:
restrict outflow of the siloxane mixed air from the flow path; and
allow the percolation of the siloxane mixed air through at least one of the first filter media and the second filter media.

15. The air intake system of claim 12, wherein the at least one siloxane separation module and one of an inner surface of the housing and an adjacent separation module define a collection passage therebetween.

16. The air intake system of claim 15, wherein the collection passage is in fluid communication with the outlet of the housing.

17. The air intake system of claim 12, wherein each of the first filter media and the second filter media comprises a plurality of pores configured to allow percolation of the siloxane mixed air therethrough, and wherein periphery of each of the plurality of pores comprises siloxane adsorbent.

18. A siloxane separation module for separating siloxane from siloxane mixed air, the siloxane separation module comprising:
a first cartridge having a first filter media configured to separate siloxane from siloxane mixed air; and
a second cartridge having a second filter media configured to separate siloxane from the siloxane mixed air, the second cartridge and the first cartridge defining a flow path between the first filter media and the second filter media, wherein the flow path is in fluid communication with the inlet of the housing.

19. The siloxane separation module of claim 18, wherein at least one of the first filter media and the second filter media allow percolation of the siloxane mixed air from the flow path to the outlet of the housing.

20. The siloxane separation module of claim 18, wherein each of the first filter media and the second filter media comprises a plurality of pores to allow percolation of the siloxane mixed air therethrough, and wherein periphery of each of the plurality of pores comprises siloxane adsorbent to adsorb siloxane from the percolating siloxane mixed air.
